(19) United States
(12) Patent Application Publication
(10) Pub. No.: US 2006/0215630 A1
(43) Pub. Date: Sep. 28, 2006

(54) Feature scalability in a multimedia communication system

(76) Inventors: Cherng-Daw Hwang, San Jose, CA (US); Steven Wang, Cupertino, CA (US); Weiping Li, Palo Alto, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/090,095

(22) Filed: Mar. 25, 2005

(51) Int. Cl. H04L 12/28; H04L 12/56

(52) U.S. Cl. 370/351; 370/400

(57) ABSTRACT

Participants in a teleconference may exchange multimedia data, such as audio, video, documents, thumbnails, white board, buddy list, control data, etc., for example. The end-point devices may be located in different locations, may have different capabilities, such as processing power, amount of random access memory, amount of graphics memory, and display size, and the links among terminals may have different bandwidths. A real-time routing server may scale features available, such as video capture/encoding size, video decoding/display size, number of video display windows, quality of video pictures, whether to have thumbnails, etc., to the end-points based on the capabilities of the particular end-point device and/or its link bandwidth to the real-time routing server.

### FIELD

Embodiments of the present invention relate to multimedia communication sessions and collaboration and in particular to allowing multiple users to communicate with each other in real time through delivery of high-quality video, audio, images, text, and documents through Internet Protocol (“IP”) networks.

### BACKGROUND

Accomplishing multi-party and multimedia communication in real time, such as teleconferencing, has been a challenging technical problem for a long time. Traditionally, specifically designed terminal devices are centrally located and participants gather in the central locations to participate in the teleconference. Dedicated lines connect each party to the television. The dedicated line can be an Integrated Services Digital Network (ISDN) line or Trunk Level 1 (T-1) line.

Today Internet Protocol (IP) networks are being used for communication between computers. Although IP networks offer advantages over dedicated lines, there is a large variation in its available bandwidth. Although computers offer more flexibility than specially designed terminal devices, there is a large variation in their capabilities.

### SUMMARY

Embodiments of the present invention relate to methods of communicating multimedia data, such as audio, video, documents, thumbnails, white board, buddy list, control data, etc., over a shared network in which end-point devices may have differing capabilities. For one embodiment, a real-time routing server may receive the multimedia data and if the real-time routing server is a source or destination real-time routing server, the real-time routing server may process the multimedia data based on capabilities of at least one destination end-point device coupled to the source or destination real-time routing server. For alternative embodiments, if the real-time routing server is a transit real-time routing server, the real-time routing server may send the multimedia data to the destination end-point device without processing the multimedia data.

If the real-time routing server is a source or destination real-time routing server, then the real-time routing server may detect bandwidth between the source or destination real-time routing server and at least one source or destination end-point device, adjust the bit rate of the multimedia data based on the bandwidth between the source or destination real-time routing server and the source or destination end-point device, and send the multimedia data from the source end-point device to the destination end-point device at the adjusted bit rate.

### BRIEF DESCRIPTION OF THE DRAWINGS

In the drawings, like reference numbers generally indicate identical, functionally similar, and/or structurally equivalent elements. The drawing in which an element first appears is indicated by the leftmost digit(s) in the reference number, in which:

FIG. 1 is a high-level block diagram of a teleconferencing system according to an embodiment of the present invention;

FIG. 2 is a flow chart illustrating an approach to operating the teleconferencing system depicted in FIG. 1 according to an embodiment of the present invention;

FIG. 3 is a high-level block diagram of a scalable feature module according to an embodiment of the present invention;

FIG. 4 is a matrix illustrating features available for scaling in a pre-scheduled teleconference according to an embodiment of the present invention;

FIG. 5 is a matrix illustrating features available for scaling in an ad hoc teleconference according to an embodiment of the present invention; and

FIG. 6 is a high-level block diagram of the teleconferencing system depicted in FIG. 1 according to an alternative embodiment of the present invention.

### DETAILED DESCRIPTION

As will be described in more detail below a video teleconferencing system integrates multimedia data such as audio, video, data collaboration, instant messaging, and chatting, for example into one system. The system has three components: one or more multimedia application routing server(s) (MARS), several end-point devices, such as one or more personal computers (PC), set-top boxes, desk-top boxes, and/or personal digital assistants (PDA), with software and a camera and a headset (or microphone and speaker) on each end-point device for users to conduct the teleconference, and a management server, which manages registered users and network components.

End-point devices wishing to participate in the teleconference register their capabilities with their home MARS, so that MARS knows the capabilities of each end-point device. A MARS can automatically detect bandwidth between the end-point devices and a MARS and between one MARS and another MARS. The home MARS for the end-point device may decide, for example, that one end-point device that is a very powerful PC, so the end-point device can encode, send, and receive large video, such as Video Graphics Array (VGA) video. The MARS will be prepared to receive large video from that end-point device. If a second end-point device has very little capability and cannot generate or receive large video, then the MARS may be prepared to receive smaller Quarter Common Intermediate Format (QCIF) video from that end-point device and the end-point device may receive and decode Quarter VGA (QVGA) video. If a third end-point device has its capability in between the first and the second end-point devices, it may encode and send QVGA video and receive and decode VGA video. In addition to video size, MARS may decide on using a different video codec for the output video from that of the input video because the receiving end-point device may not have the same video codec as the sending end-point. Moreover, MARS may perform similar operations to audio and data to bridge the differences between sending and receiving end-points in terms of their different capabilities in encoding and decoding audio and data.

In this manner, the MARS scales the features available to the individual end-point devices so that end-point devices with different computing powers receive features compatible with their capabilities, whether its audio and document sharing for a hand-held device, such as a PDA, or QCIF video, QVGA video, or other features for end-point devices with greater or lesser capabilities. Also, because of the individual end-point devices, users do not have to go to a central location to participate in the teleconference but instead may participate from their desk top.

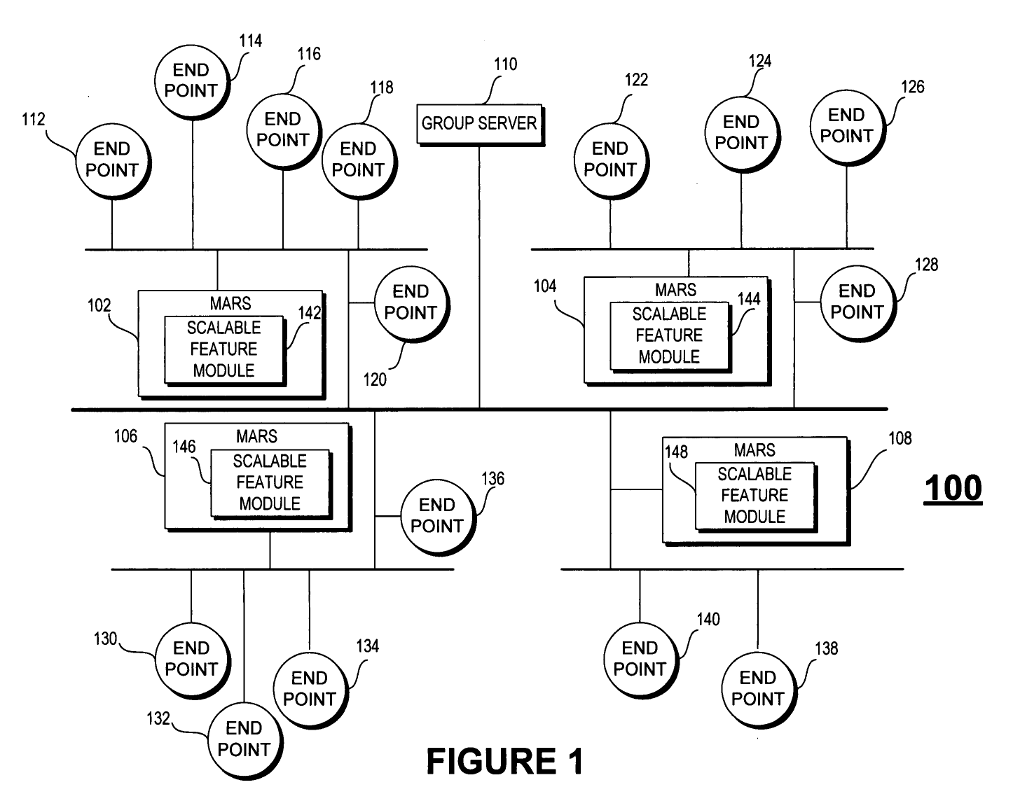

FIG. 1 is a high-level block diagram of a teleconferencing system 100 according to an embodiment of the present invention. In the illustrated embodiment, the system 100 includes a Multimedia Application Routing Server (MARS) 102, a MARS 104, a MARS 106, and a MARS 108. Each illustrated MARS 102, 104, 106, and 108 is coupled to a group server 110 and several end-point devices over a network, such as an Internet Protocol (IP) network or other suitable network, for example.

The illustrated MARS 102 is coupled to several end-point devices 112, 114, 116, 118, and 120. The illustrated MARS server 104 is coupled to several end-point devices 122, 124, 126, and 128. The illustrated MARS 106 is coupled to several end-point devices 130, 132, 134, and 136. The illustrated MARS 108 is coupled to several end-point devices 138 and 140. The illustrated MARS 102 includes a scalable feature module 142, the illustrated MARS 104 includes a scalable feature module 144, the illustrated MARS 106 includes a scalable feature module 146, and the illustrated MARS 108 includes a scalable feature module 148.

The example teleconferencing system 100 may allow users of the end-point devices to send and receive multimedia data in real time with minimal delay so that the users can communicate and collaborate with each other.

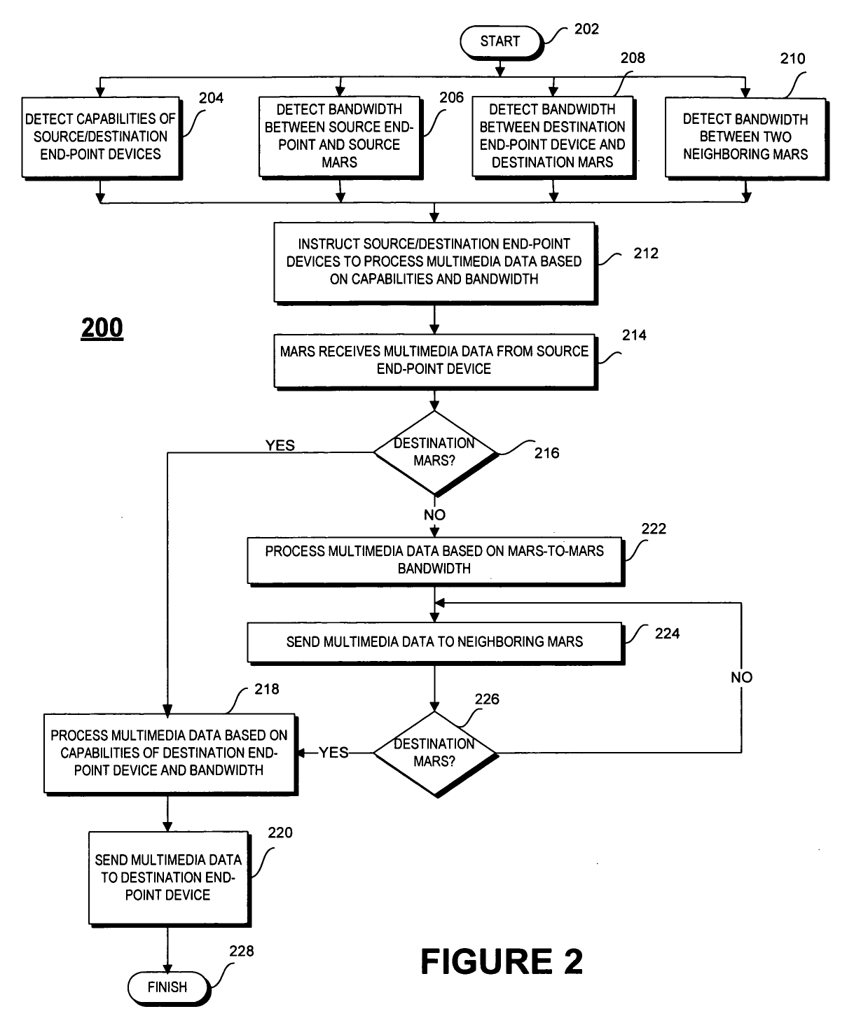

An individual MARS (102, 104, 106, or 108) may route multimedia data and process multimedia data in real time. Accordingly, a MARS may be referred to herein as a real-time routing server. A MARS may utilize any suitable technique for finding a route for the multimedia data. An individual real-time routing server (102, 104, 106, or 108) may process multimedia data using its associated scalable feature module (142, 144, 146, 148), as will be described below with reference to FIGS. 2-6.

The group server 110 may manage multimedia communications sessions over the network of the system 100. In the group server 110, there may be several software processes running to manage communication sessions within the group server 110's group of users. There also may be several software processes running to exchange information with other group servers 110 so that session may be conducted across groups. The software processes running in the group server 110 may include a provisioning server, a web server, and processes relating to multimedia collaboration and calendar management. For one embodiment, the group server 110 may use the Linux operating system.

An individual end-point device (112, 114, 116, 118, 120, 122, 124, 126, 128, 130, 132, 134, 136, 138, or 140) may be a personal computer (“PC”) running as a software terminal, a dedicated hardware device connection with user interface devices, and/or a combination of a PC and a hardware device. The example individual end-point device may be used for a human user to schedule and conduct a multimedia communication session. The example individual end-point device may be capable of capturing inputs from user interface devices, such as a video camera, an audio microphone, a pointing device (such as a mouse, for example), a typing device such as a keyboard, for example, and any image/text display on the monitor. The example individual end-point device also may be capable of sending outputs to user interface devices such as a PC monitor, a TV monitor, a speaker, and an earphone, for example.

The example individual end-point device also may encode and decode multimedia data according to the network bandwidth and the computing power of the particular end-point device. The example individual end-point device may send encoded multimedia data to its associated the real-time routing server, receive encoded multimedia data from its associated real-time routing server, may decode the multimedia data and send the decoded multimedia data to the output devices.

The example individual end-point device also may process communication messages transmitted between the example individual end-point device and its associated real-time routing server. The messages may include scheduling a meeting, joining a meeting, inviting another user to a meeting, exiting a meeting, setting up a call, answering a call, ending a call, taking control of a meeting, arranging video positions of the meeting participants, updating buddy list status, checking the network connection with the real-time routing server, and so on.

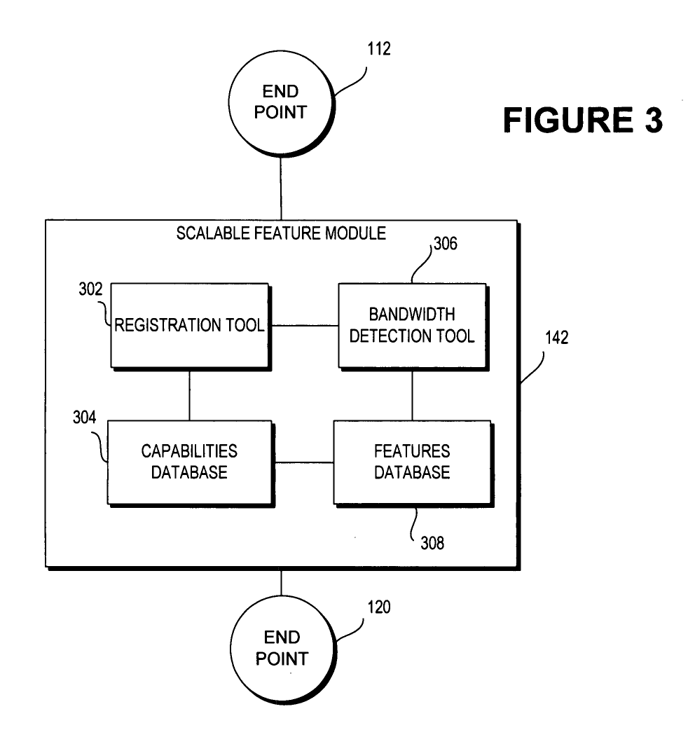

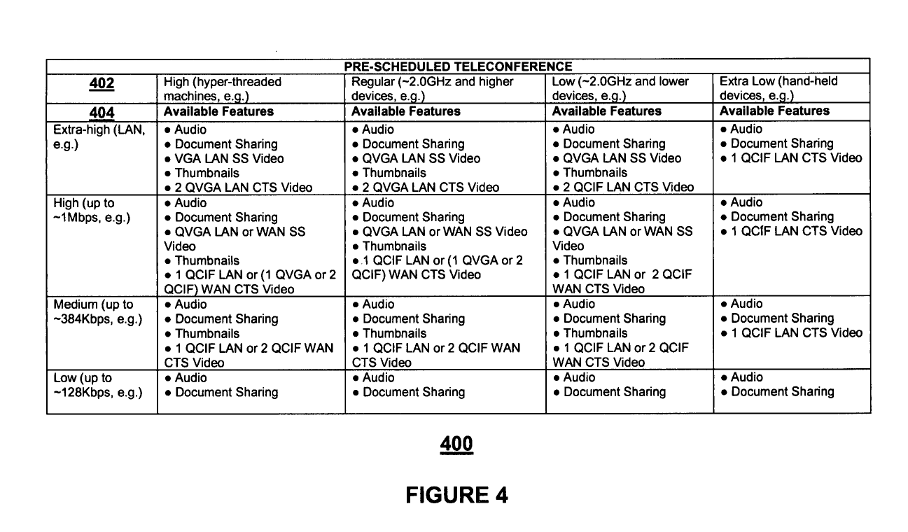

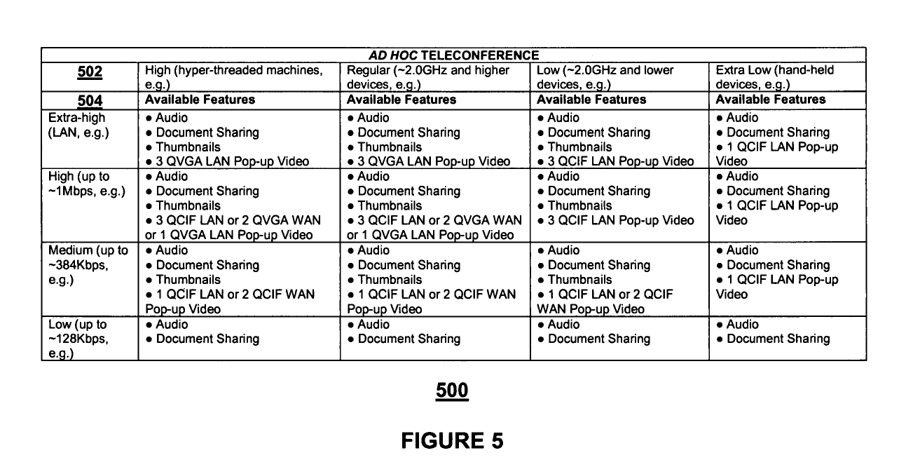

FIG. 2 is a flowchart illustrating a method 200 for operating the system 100 according to an embodiment of the present invention. The method 200 will be described with reference to FIG. 3, which is a high-level block diagram of the scalable feature module 142 according to an embodiment of the present invention, with reference to FIG. 4, which is a matrix 400 defined by the real-time routing server 102 illustrating end-point device capabilities and associated available features during a pre-scheduled teleconference according to an embodiment of the present invention, and with reference to FIG. 5, which is a matrix 500 defined by the real-time routing server 102 illustrating end-point device capabilities and associated available features during an ad hoc teleconference according to an embodiment of the present invention.

The illustrated scalable feature module 142 includes a capabilities registration tool 302, a capabilities database 304, a bandwidth detection tool 306, and a features database 308 coupled to each other. For one embodiment, the source end-point device 112 and the destination end-point device 120 may utilize their capabilities detection tools, which may be a software program, such as any suitable application programming interface (API), for example, to detect their capabilities. Such capabilities may include processor type, processing or computing power, memory type and/or amount, graphics capabilities, audio capabilities, etc., for example. The source and destination end-point devices 112 and 120 may register their capabilities with the real-time routing server 102, using the capabilities registration tool 302 and store the capabilities in the capabilities database 304.

The capabilities database 304 may store this and other information for each communication session for all the registered end-point devices. The information in the capabilities database 304 for each end-point device thus may include connection bandwidth, computing power, display capability, IP address, login user name, and ID (email address), video display layout, list of bit streams, etc. The capabilities database 304 on the intermediate real-time routing server may not keep information on the end-point devices that are not associated with that real-time routing server. Based on such information, a real-time routing server can determine what kind of operations it may want to perform on multimedia data and/or end-point devices.

The bandwidth detection tool 306 may measure the bandwidth capacity between any two real-time routing server units using packet dispersion techniques, for example. The bandwidth detection tool 306 also may measure the bandwidth capacity between a real-time routing server and an end-point using any suitable packet dispersion technique, for example.

The matrix 400 includes a row 402 listing possible computing power of end-point devices according to an embodiment of the present invention and a column 404 listing possible bandwidths between a real-time routing server and an end-point device according to an embodiment of the present invention. The matrix 500 includes a row 502 listing possible computing power of end-point devices according to an embodiment of the present invention and a column 504 listing possible bandwidths between a real-time routing server and an end-point device according to an embodiment of the present invention. For purposes of illustration, assume that the source end-point device 112 may wish to send multimedia data to the destination end-point device 120. In alternative embodiments, a source end-point device may wish to send multimedia data to more than one destination end-point device.

The method 200 begins with a block 202, where control may pass to a block 204. In the block 204, the source end-point device 112 and the destination end-point device 120 may detect their capabilities and register their capabilities with MARS 102. For one embodiment, the source end-point device 112 and the destination end-point device 120 may utilize a software program, such as any suitable application programming interface (API), for example, to detect its capabilities. Such capabilities may include processor type, processing or computing power, memory type and/or amount, graphics capabilities, audio capabilities, etc., for example. The real-time routing server 102 may register the capabilities of the source and destination end-point devices 112 and 120, respectively, using the capabilities registration tool 302 and store the capabilities in the capabilities database 304.

When the method 200 begins with the block 202, control also may pass to a block 206, in which the real-time routing server 102 may detect the bandwidth between the source end-point device 112 and the real-time routing server 102. For one embodiment, the bandwidth between the source end-point device 112 and the real-time routing server 102 may be classified as Extra-high (local area network (LAN), e.g.). Such a bandwidth detection operation may be performed at the time when the end-point device 112 comes on-line, periodically thereafter, and/or before the end-point device 112 starts or joins a communication session.

When the method 200 begins with the block 202, control also may pass to a block 208, in which the real-time routing server 102 may detect the bandwidth between the destination end-point device 120 and the real-time routing server 102. For one embodiment, the bandwidth between the destination end-point device 120 and the real-time routing server 102 may be classified as Extra-high (local area network (LAN), e.g.). Such a bandwidth detection operation may be performed at the time when the end-point device 120 comes on-line, periodically thereafter, and/or before the end-point device 120 starts or joins a communication session.

When the method 200 begins with the block 202, control also may pass to a block 210, in which the real-time routing servers 102 and 104 may detect the bandwidth between themselves. For one embodiment, the bandwidth between the real-time routing servers 102 and 104 may be 2 Mbits per second. Such a bandwidth detection operation may be performed at the time when a real-time routing server comes on-line, periodically thereafter, and/or before a communication session starts.

In a block 212, the real-time routing server 102 may instruct the source end-point device 112 to process its multimedia data in accordance with the capabilities of the destination end-point device 120 as well as in accordance with the detected bandwidth. For example, in embodiments in which the destination end-point device 120 may be classified as a High computing power end-point device (e.g., a hyper-threaded machine) with an Extra-high (LAN, e.g.) bandwidth, the real-time routing server 102 may instruct the destination end-point device 120 to decode the multimedia data bit stream into VGA LAN split screen (SS) video and up to 2 QVGA LAN click-to-see (CTS) video for a pre-scheduled teleconference or 3 QVGA LAN Pop-up Video for an ad hoc teleconference, and to include these features along with audio, document sharing, and thumbnails in the multimedia data. For embodiments in which the source end-point device 112 may be classified as a High computing power end-point device (e.g., a hyper-threaded machine) with an Extra-high (LAN, e.g.) bandwidth as well, the real-time routing server 102 may instruct the source end-point device 112 to encode QVGA video along with audio, document sharing, and thumbnails in the multimedia data. The real-time routing server 102 may not need to process the video data from the source end-point device 112 but may forward them to the destination end-point 120.

The source end-point device 112 may include the appropriate codec (not shown) and may have the capabilities to encode the multimedia data into the formats as instructed by the real-time routing server 102. In this embodiment, the source end-point device 112 may encode the multimedia data as instructed. If the source end-point device 112 cannot encode the multimedia data as instructed by the real-time routing server 102, because, for example, computing resources have become limited due to other programs being run, then the source end-point device 112 may encode the multimedia data as best it can.

For embodiments of the present invention, the source end-point device 112 may encode the multimedia data according to one of several coding schemes, such as International Telecommunication Union (ITU) coding standards (H.261, H.263, H.264) or International Organization for Standardization (ISO) coding standards (Moving Picture Expert Group (MPEG) 1, 2, 4) or other national coding standards. The source end-point device 112 may send the encoded multimedia data to the real-time routing server 102.

In a block 214, the real-time routing server 102 may receive the encoded multimedia data from the source end-point 112.

In a block 216, the real-time routing server 102 may determine whether it is also the destination real-time routing server for the multimedia data sent to destination end-point device 120 from the source end-point device 112. In keeping with the illustrated embodiment in which the source end-point device 112 may wish to send multimedia data to the destination end-point device 120, the real-time routing server 102 also may be the destination real-time routing server and control of the method 200 may pass to a block 218.

In a block 218, the real-time routing server 102 may process multimedia data according to the capabilities of the destination end-point device 120 and the bandwidth between the real-time routing server 102 and the destination end-point device 120.

In a block 220, the real-time routing server 102 may send processed or un-processed multimedia data to the destination end-point device 120.

In a block 228, the process 200 finishes.

If, on the other hand, in the block 216, the real-time routing server 102 may determine that it is not the destination real-time routing server for the multimedia data sent to the destination end-point device 122 from the source end-point device 112, then control of the method 200 passes to a block 222. The real-time routing server 102 may process multimedia data according to the bandwidth between itself and the real-time routing server 104, which is the destination real-time routing server for the destination end-point device 122.

In a block 224, real-time routing server 102 may send processed or un-processed multimedia data to next real-time routing server 104.

In a block 226, the real-time routing server 104 may determine whether it is the destination real-time routing server for the multimedia data sent to destination end-point 122 from the source end-point 112. In keeping with the illustrated embodiment in which the source end-point device 112 may wish to send multimedia data to the destination end-point device 122, the real-time routing server 104 may be the destination real-time routing server and control of the method 200 may pass to a block 218.

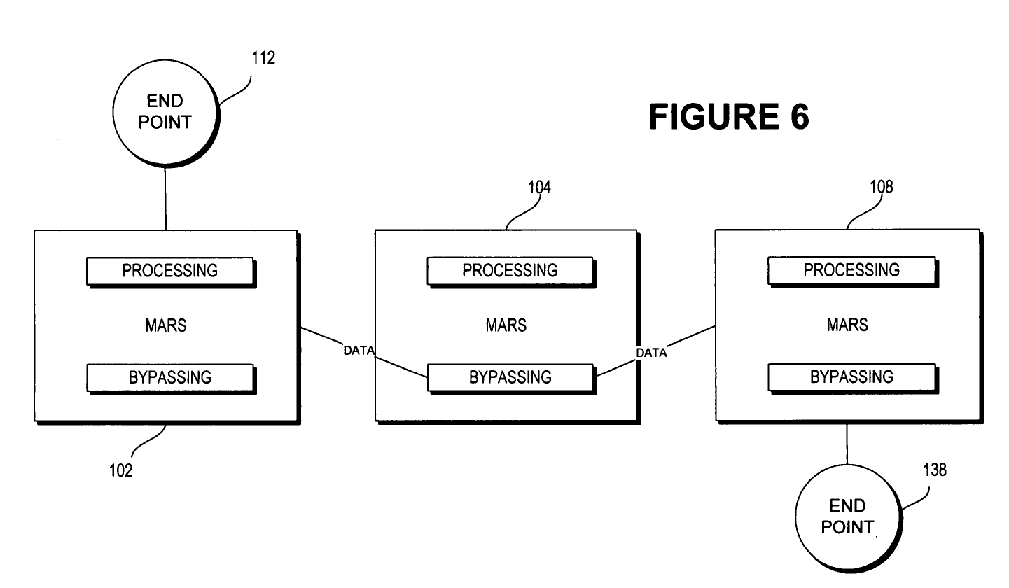

If, on the other hand, in the block 226, the real-time routing server 104 may determine that it is not the destination real-time routing server for the multimedia data sent to the destination end-point device 138 from the source end-point device 112, then control of the method 200 passes back to the block 224. The real-time routing server 104 may be a transit real-time routing server and may not process the multimedia data. FIG. 6 is a high-level block diagram of the system 100, which illustrates an alternative embodiment in which the source end-point 112 may wish to send multimedia data to the destination end-point 138. In the illustrated embodiment, the multimedia data goes from the source real-time routing server 102 to the transit real-time routing server 104 and to the destination real-time routing server 108.

In the block 224, the multimedia data may bypass the processing portion of the real-time routing server 104 that may send the multimedia data to the real-time routing server 108 without processing the multimedia data. Because according to the example the real-time routing server 108 may be the destination real-time routing server, the real-time routing server 108 may then perform a block similar to the block 218.

Embodiments of the present invention may be implemented using hardware, software, or a combination thereof. In implementations using software, the software may be stored on a machine-accessible medium.

A machine-accessible medium includes any mechanism that may be adapted to store and/or transmit information in a form accessible by a machine (e.g., a computer, network device, personal digital assistant, manufacturing tool, any device with a set of one or more processors, etc.). For example, a machine-accessible medium includes recordable and non-recordable media (e.g., read only memory (ROM), random access memory (RAM), magnetic disk storage media, optical storage media, flash memory devices, etc.), such as electrical, optical, acoustic, or other form of propagated signals (e.g., carrier waves, infrared signals, digital signals, etc.).

In the above description, numerous specific details, such as, for example, particular processes, materials, devices, and so forth, are presented to provide a thorough understanding of embodiments of the invention. One skilled in the relevant art will recognize, however, that the embodiments of the present invention may be practiced without one or more of the specific details, or with other methods, components, etc. In other instances, structures or operations are not shown or described in detail to avoid obscuring the understanding of this description.

Reference throughout this specification to “one embodiment” or “an embodiment” means that a particular feature, structure, process, block, or characteristic described in connection with an embodiment is included in at least one embodiment of the present invention. Thus, the appearance of the phrases “for one embodiment” or “in an embodiment” in various places throughout this specification does not necessarily mean that the phrases all refer to the same embodiment. The particular features, structures, or characteristics may be combined in any suitable manner in one or more embodiments.

In practice, the methods described herein may constitute one or more programs made up of machine-executable instructions. Describing the method with reference to the flow charts enables one skilled in the art to develop such programs, including such instructions to carry out the operations (acts) represented by the logical blocks on suitably configured computer or other types of processing machines (the processor of the machine executing the instructions from machine-readable media). The machine-executable instructions may be written in a computer programming language or may be embodied in firmware logic. If written in a programming language conforming to a recognized standard, such instructions can be executed on a variety of hardware platforms and for interface to a variety of operating systems.

In addition, embodiments of the invention are not limited to any particular programming language. A variety of programming languages may be used to implement embodiments of the invention.

Furthermore, it is common in the art to speak of software, in one form or another (i.e., program, procedure, process, application, module, logic, etc.), as taking an action or causing a result. Such expressions are merely a shorthand way of saying that execution of the software by a machine caused the processor of the machine to perform an action or produce a result. More or fewer processes may be incorporated into the methods illustrated without departing from the scope of the invention and that no particular order is implied by the arrangement of blocks shown and described herein.

Embodiments of the invention have been described. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method of communicating multimedia data over a network, comprising:
receiving the multimedia data at a real-time routing server;
if the real-time routing server is a source real-time routing server and/or a destination real-time routing server, then possibly processing the multimedia data based on capabilities of at least one destination end-point device and/or bandwidth from the source end-point to the destination end-point;
if the real-time routing server is a source real-time routing server, but not a destination real-time routing server, sending the possibly processed multimedia data to the source real-time routing server's neighboring real-time routing server;
if the real-time routing server is a destination real-time routing server, sending the possibly processed multimedia data to the destination end-point device; and
if the real-time routing server is a transit real-time routing server, then sending the possibly processed multimedia data to a next real-time routing server without processing the data.

2. The method of claim 1, further comprising if the real-time routing server is a source real-time routing server, then instructing a source end-point device to encode the multimedia data.

3. The method of claim 2, further comprising receiving the multimedia data from the source end-point device.

4. The method of claim 2, further comprising receiving encoded multimedia data from the source end-point device, the encoded multimedia data being encoded in accordance with instructing the source end-point device to encode the multimedia data.

5. The method of claim 1, further comprising storing capabilities if the real-time routing server is a destination real-time routing server or a source real-time routing server.

6. The method of claim 5, further comprising processing the multimedia data based on at least one capability chosen from the group of computing power, memory, graphics, and bandwidth.

7. The method of claim 6, further comprising performing at least one operation chosen from the group of adjusting a resolution of video in the multimedia data, removing video from the multimedia data, and removing one or more thumbnails from the multimedia data based on at least one capability.

8. The method of claim 1, further comprising defining categories for end-point devices based on capabilities.

9. A method of communicating multimedia data over a network, comprising:
receiving the multimedia data at a real-time routing server, the multimedia data having a bit rate;
if the real-time routing server is a destination real-time routing server, then detecting bandwidth between the destination real-time routing server and at least one destination end-point device, adjusting the bit rate of the multimedia data based on the bandwidth between the destination real-time routing server and the destination end-point device, and sending the multimedia data to the destination end-point device; and
if the real-time routing server is a transit real-time routing server, then sending the multimedia data to the destination real-time routing server.

10. The method of claim 9, further comprising detecting bandwidth between a source end-point device and a source real-time routing server.

11. The method of claim 10, further comprising receiving the multimedia data from the source end-point device.

12. The method of claim 9, further comprising performing at least one operation chosen from the group of adjusting a resolution of video in the multimedia data, removing video from the multimedia data, and removing one or more thumbnails from the multimedia data based on the detecting bandwidth between the transit real-time routing server and a destination real-time routing server.

13. A system, comprising:
a real-time routing server to receive multimedia data; and
an article of manufacture comprising a machine-accessible medium including data that, when accessed by a machine cause the machine to perform operations comprising:
detecting capabilities of at least one end-point device;
communicating the capabilities to the real-time routing server;
wherein the real-time routing server is to scale the multimedia data content based on the capabilities of the end-point device if the real-time routing server is a destination real-time routing server, or send the multimedia data to a destination real-time routing server if the real-time routing server is a transit real-time routing server.

14. The system of claim 13, wherein the real-time routing server comprises a database to store capabilities of the end-point device.

15. The system of claim 13, wherein the real-time routing server is to perform an operation chosen from at least one of adjusting a resolution of video in the multimedia data, removing video from the multimedia data, and removing one or more thumbnails from the multimedia data based on at least one capability.

16. A method of communicating multimedia data over a network, comprising:
receiving the multimedia data at a real-time routing server, the multimedia data having a bit rate;
if the real-time routing server is a destination real-time routing server, then detecting bandwidth between the destination real-time routing server and at least one destination end-point device, adjusting the bit rate of the multimedia data based on the bandwidth between the destination real-time routing server and the destination end-point device, and sending the multimedia data to the destination end-point device; and
if the real-time routing server is a transit real-time routing server, then detecting bandwidth between the transit real-time routing server and a destination real-time routing server, adjusting the bit rate of the multimedia data based on the bandwidth between the transit real-time routing server and the destination real-time routing server, and sending the multimedia data to the destination real-time routing server.

17. The method of claim 16, further comprising if the real-time routing server is a destination real-time routing server, performing at least one operation chosen from the group of adjusting a resolution of video in the multimedia data, removing video from the multimedia data, and removing one or more thumbnails from the multimedia data based on the detecting bandwidth between the transit real-time routing server and a destination real-time routing server.

18. An apparatus, comprising:
a real-time routing server receive multimedia data from a source end-point device, to detect capabilities of at least one destination end-point device, to scale the multimedia data content based on the capabilities of the destination end-point device if the real-time routing server is a destination real-time routing server, or send the multimedia data to a destination real-time routing server if the real-time routing server is a transit real-time routing server.

19. The apparatus of claim 18, wherein the multimedia data content to be scaled includes at least one selected from the group of video, audio, thumbnails, white boards, and document sharing being removed from the multimedia data content and/or made smaller in the multimedia data content.
